(19) United States
(12) Patent Application Publication
(10) Pub. No.: US 2024/0046682 A1
(43) Pub. Date: Feb. 8, 2024

(54) Interaction Method, Electronic Device and Computer Storage Medium

(71) Applicant: BOE Technology Group Co., Ltd., (US)

(72) Inventors: Fengshuo HU, Beijing (CN); Guangwei HUANG, Beijing (CN); Yangyang ZHANG, Beijing (CN)

(21) Appl. No.: 17/765,832

(22) PCT Filed: May 28, 2021
(86) PCT No.: PCT/CN2021/096925

§ 371 Date: Mar. 31, 2022

(51) Int. Cl. G06V 30/32; G06F 3/04883; G06F 3/0482

(52) U.S. Cl. CPC G06V 30/387; G06F 3/04883; G06V 30/347; G06V 30/373; G06F 3/0482; G06F 3/04817

(57) ABSTRACT

An interaction method, an electronic device and a computer storage medium. The interaction method includes: acquiring a trajectory point set input by a user, wherein the trajectory point set at least includes one trajectory point; determining a candidate object according to the trajectory point set, wherein the candidate object includes a first candidate object and a second candidate object; displaying a first selection icon for representing the first candidate object and a second selection icon for representing the second candidate object; and displaying the first candidate object or executing an operation corresponding to the first candidate object in response to the user's selection operation on the first selection icon, and displaying the second candidate object or executing an operation corresponding to the second candidate object in response to the user's selection operation on the second selection icon.

### CROSS-REFERENCE TO RELATED APPLICATION

The present application is a U.S. National Phase Entry of International Application PCT/CN2021/096925 having an international filing date of May 28, 2021, and the contents disclosed in the above-mentioned application are hereby incorporated as a part of this application.

### TECHNICAL FIELD

The present disclosure relates to, but is not limited to, the field of computer technologies, in particular to an interaction method, an electronic device, and a computer storage medium.

### BACKGROUND

Paperless working and learning through electronic devices has gradually replaced the traditional way and become the mainstream. Electronic devices such as electronic whiteboard, mobile phone/tablet computer with touch screens provide users with function of writing and drawing directly with fingers or stylus on the screen. However, when a user want to input a required graphic, they need a series of operations such as searching, copying, pasting or inserting, which is inconvenient and inefficient.

### SUMMARY

The following is a summary of subject matters described herein in detail. The summary is not intended to limit the scope of protection of claims.

An embodiment of the present application provides an interaction method, an electronic device and a computer storage medium.

In an aspect, an embodiment of the present application provides an interaction method, including steps of:

acquiring a trajectory point set input by a user, wherein the trajectory point set at least includes one trajectory point;

determining a candidate object according to the trajectory point set, wherein the candidate object includes a first candidate object and a second candidate object;

displaying a first selection icon for representing the first candidate object and a second selection icon for representing the second candidate object; and

displaying the first candidate object or executing an operation corresponding to the first candidate object in response to the user's selection operation on the first selection icon, and displaying the second candidate object or executing an operation corresponding to the second candidate object in response to the user's selection operation on the second selection icon.

In an exemplary embodiment, the first candidate object includes a first candidate pattern, and the second candidate object includes a second candidate pattern;

the step of displaying the first candidate object in response to the user's selection operation on the first selection icon, and displaying the second candidate object in response to the user's selection operation on the second selection icon includes:

displaying the first candidate pattern in response to the user's selection operation on the first selection icon, and displaying the second candidate pattern in response to the user's selection operation on the second selection icon;

the step of determining the candidate object according to the trajectory point set includes:

acquiring first feature information according to the trajectory formed by the trajectory point set, and acquiring a first candidate pattern successfully matched with the first feature information, and

acquiring second feature information according to a trajectory formed by the trajectory point set, and acquiring a second candidate pattern successfully matched with the second feature information;

wherein the first feature information is different from the second feature information.

In an exemplary embodiment, the first feature information and the second feature information respectively include one or more of the following:

one or more character features corresponding to the trajectory;

an original line feature of a pattern formed by the trajectory; and

a contour line feature of the pattern formed by the trajectory.

In an exemplary embodiment, the first feature information or the second feature information includes one or more character features corresponding to the trajectory;

the step of acquiring the first feature information or the second feature information according to the trajectory formed by the trajectory point set includes:

acquiring one or more character features corresponding to the trajectory formed by the trajectory point set;

the step of acquiring the first/second candidate pattern successfully matched with the first/second feature information includes:

selecting a candidate pattern with a carried label which is at least partially the same character feature in the first/second feature information as the first/second candidate pattern;

wherein the label carried by the candidate pattern is used for representing contents of the candidate pattern.

In an exemplary embodiment, the first feature information or the second feature information includes an original line feature of the pattern formed by the trajectory;

the step of acquiring the first/second candidate pattern successfully matched with the first/second feature information includes:

respectively calculating a first similarity between each candidate pattern and the original line feature in the first/second feature information; and

selecting a candidate pattern whose first similarity meets a first preset condition as the first/second candidate pattern.

In an exemplary embodiment, the first feature information or the second feature information includes an original line feature of the pattern formed by the trajectory;

the step of acquiring the first/second candidate pattern successfully matched with the first/second feature information includes:

performing the following operations respectively for each candidate pattern:

calculating a similarity between the original line feature in the first/second candidate pattern and the candidate pattern, and a similarity between the original line feature and a sub-pattern included in the candidate pattern, so as to determine a second similarity with the candidate pattern; and

selecting a candidate pattern whose second similarity meets a second preset condition as the first/second candidate pattern;

wherein the sub-pattern included in the candidate pattern is stored corresponding to the candidate pattern.

In an exemplary embodiment, the first feature information or the second feature information includes a contour line feature of the pattern formed by the trajectory;

the step of acquiring the first/second candidate pattern successfully matched with the first/second feature information includes:

respectively calculating a third similarity between a contour line of each candidate pattern and the contour line feature in the first/second feature information; and

selecting the candidate pattern whose third similarity meets a third preset condition as the first/second candidate pattern.

In an exemplary embodiment, the first candidate includes a first candidate instruction, and the second candidate includes a second candidate instruction;

the step of executing the operation corresponding to the first candidate object in response to the user's selection operation on the first selection icon and executing the operation corresponding to the second candidate object in response to the user's selection operation on the second selection icon includes:

executing an operation corresponding to the first candidate instruction in response to the user's selection operation on the first selection icon, and executing the operation corresponding to the second candidate instruction in response to the user's selection operation on the second selection icon;

the step of determining the candidate object according to the trajectory point set includes:

identifying a trajectory formed by the trajectory point set as a standard trajectory, and

acquiring different candidate instructions according to the standard trajectory as the first candidate instruction and the second candidate instruction respectively.

In an exemplary embodiment, the first candidate object is a third candidate pattern, and the second candidate object is a third candidate instruction;

the step of displaying the first candidate object in response to the user's selection operation on the first selection icon and executing the operation corresponding to the second candidate object in response to the user's selection operation on the second selection icon includes:

displaying the third candidate pattern in response to the user's selection operation on the first selection icon, and executing an operation corresponding to the third candidate instruction in response to the user's selection operation on the second selection icon;

the step of determining the candidate object according to the trajectory point set includes:

acquiring third feature information according to a trajectory formed by the trajectory point set, and acquiring a third candidate pattern successfully matched with the third feature information; and

identifying the trajectory formed by the trajectory point set as a standard trajectory, and acquiring the third candidate instruction according to the standard trajectory.

In an exemplary embodiment, the step of determining the candidate object according to the trajectory point set further includes:

acquiring a fourth feature information according to a trajectory formed by the trajectory point set in response to a failure of identifying the trajectory formed by the trajectory point set as a standard trajectory, and acquiring a fourth candidate pattern successfully matched with the fourth feature information as the second candidate object, wherein the fourth feature information is different from the third feature information.

In an exemplary embodiment, the interaction method is used to writing software, wherein the step of acquiring the trajectory point set input by the user includes:

acquiring the trajectory point set input by the user in an input interface in response to the user's input operation in the input interface of the writing software;

the step of displaying the first selection icon for representing the first candidate object and the second selection icon for representing the second candidate object includes:

displaying the first selection icon for representing the first candidate object and the second selection icon for representing the second candidate object in the input interface;

the step of displaying the first candidate object or executing the operation corresponding to the first candidate object in response to the user's selection operation on the first selection icon, and displaying the second candidate object or executing the operation corresponding to the second candidate object in response to the user's selection operation on the second selection icon includes:

displaying the first candidate object in the input interface or executing the operation corresponding to the first candidate object in the writing software in response to the user's selection operation on the first selection icon in the input interface; and

displaying the second candidate object in the input interface or executing the operation corresponding to the second candidate object in the writing software in response to the user's selection operation on the second selection icon in the input interface.

In an exemplary embodiment, the step of displaying the first selection icon for representing the first candidate object and the second selection icon for representing the second candidate object includes:

displaying a thumbnail of the first candidate object as the first selection icon in a case that the first candidate object is a candidate pattern; or displaying description information of the first candidate object as the first selection icon in a case that the first candidate object is a candidate instruction; and

displaying a thumbnail of the second candidate object as the first selection icon in a case that the second candidate object is a candidate pattern; or displaying description information of the second candidate object as the second selection icon in a case that the second candidate object is a candidate instruction;

In an exemplary embodiment, the step of displaying the first selection icon for representing the first candidate object and the second selection icon for representing the second candidate object further includes:

updating the determined first candidate object and/or second candidate object in response to a predetermined operation by the user; and

updating the displayed first selection icon correspondingly in response to update of the first candidate object; and updating the displayed second selection icon correspondingly in response to the update of the second candidate.

In an exemplary embodiment, the step of acquiring the trajectory point set input by the user includes:

displaying a preset control in response to a pause of the user's input operation; wherein detecting the pause of the user's input operation means that a time length from the last time a sampling result of the input operation is received reaches or exceeds a preset time threshold; and

acquiring trajectory points corresponding to the user's input operation between a current detection of the user's input operation pause and a previous detection of the user's input operation pause in response to the user's operation on the preset control, and saving the trajectory points as the trajectory point set.

In another aspect, an embodiment of the present application provides an electronic device, including a memory and a processor; wherein the memory is configured to store a program for interaction, and the processor is configured to read and execute the program for interaction and perform the aforementioned interaction method.

In another aspect, an embodiment of the present application provides a computer storage medium configured to store a program for interaction, wherein the aforementioned interaction method is performed when the program for interaction is executed.

The embodiments of the present disclosure may automatically, efficiently and quickly provide various candidate objects related to the trajectory for the user to choose according to the trajectory formed by the user input, and may display corresponding patterns or perform corresponding operations according to the user's choice, thus greatly improving the user's experience.

Other aspects may be understood after the accompanying drawings and detailed descriptions are read and understood.

### BRIEF DESCRIPTION OF DRAWINGS

Accompanying drawings are used to provide a further understanding of technical solutions of the present disclosure and form a part of the specification. They are used to explain the technical solutions of the present application together with embodiments of the present disclosure, and do not constitute a limitation on the technical solutions of the present disclosure. Shapes and sizes of one or more components in the drawings do not reflect actual scales, and are only intended to schematically describe the contents of the present disclosure.

FIG. 1 is a schematic flowchart of an interaction method according to an embodiment of the present application.

FIG. 2 is a schematic diagram of an electronic device according to an embodiment of the present application.

FIG. 3 is a schematic diagram of an implementation process of Example 1.

FIG. 4 is a schematic diagram of a trajectory formed by a trajectory point set in Example 1.

FIG. 5 is a schematic diagram of displaying a selection icon in Example 1.

FIG. 6 is a schematic diagram of a process of calculating a similarity of a contour line line in Example 1.

FIG. 7 is a schematic diagram when a pattern formed by a trajectory is similar to a sub-pattern of a candidate pattern in Example 1.

FIG. 8 is a schematic diagram of a candidate pattern constituted of a sub-pattern in Example 1.

FIG. 9 is a schematic diagram of displaying a selection icon in Example 2.

### DETAILED DESCRIPTION

Hereinafter, embodiments of the present application will be described in detail with reference to the accompanying drawings. Implementation modes may be implemented in various forms. Those of ordinary skills in the art may easily understand such a fact that implementation modes and contents may be transformed into one or more forms without departing from the purpose and scope of the present disclosure. Therefore, the present disclosure should not be construed as only being limited to the contents recorded in the following embodiments. The embodiments in the present disclosure and features in the embodiments may be combined randomly with each other if there is no conflict.

In the drawings, size/sizes of one or more constituent elements, thicknesses of layers, or regions are sometimes exaggerated for clarity. Therefore, one implementation mode of the present disclosure is not necessarily limited to the sizes, and the shapes and sizes of multiple components in the accompanying drawings do not reflect actual scales. In addition, the drawings schematically show ideal examples, and implementations of the present disclosure are not limited to the shapes or values shown in the drawings.

Ordinal numerals such as “first”, “second”, and “third” herein are set to avoid confusion between constituent elements, but are not intended to limit in terms of quantity. “Multiple/multiple” in the present disclosure means a quantity of two or more.

In the present disclosure, sometimes for convenience, wordings “central”, “up”, “down”, “front”, “back”, “vertical”, “horizontal”, “top”, “bottom”, “inside”, “outside” and the like indicating directional or positional relationships are used to illustrate positional relationships between constituent elements with reference to the drawings. These terms are not intended to indicate or imply that involved devices or elements must have specific orientations and be structured and operated in the specific orientations but only to facilitate describing the present specification and simplify the description, and thus should not be understood as limitations on the present disclosure. The positional relationships between the constituent elements may be changed as appropriate based on the directions according to which the constituent elements are described. Therefore, it is not limited to the wordings described in the specification, which may be replaced appropriately according to a situation.

Herein, unless otherwise specified and defined explicitly, terms “mount”, “mutually connect”, “connect” and the like should be understood in a broad sense. For example, a connection may be a fixed connection, or a detachable connection, or an integral connection, it may be a mechanical connection or an electric connection, it may be a direct connection, or an indirect connection through an intermediate, or an internal communication between two elements. Those of ordinary skills in the art may understand the meanings of the above terms in the present disclosure according to situations.

Herein, an “electrical connection” includes a case that constituent elements are connected together by an element with a certain electrical effect. The “element with the certain electric effect” is not particularly limited as long as electric signals between the connected composition elements may be transmitted. Examples of the “element with the certain electrical action” not only include electrodes and wirings, but also include switching elements such as transistors, resistors, inductors, capacitors, other elements with one or more functions, etc.

In the present disclosure, “parallel” refers to a state in which an angle formed by two straight lines is above −10° and below 10°, and thus may include a state in which the angle is above −5° and below 5°. In addition, “perpendicular” refers to a state that an angle formed by two straight lines is above 80° and below 100°, and thus may include a state that the angle is above 85° and below 95°.

“About” herein refers to that a boundary is defined not so strictly and numerical values within process and measurement error ranges are allowed.

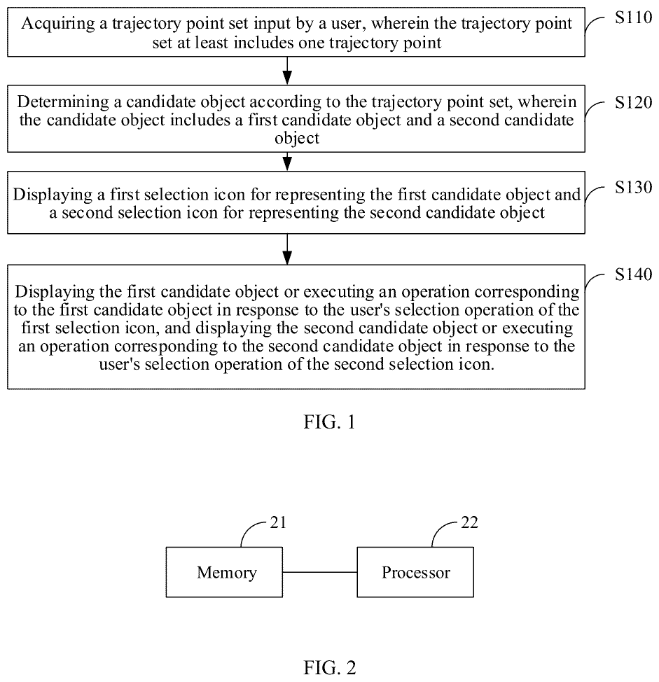

An embodiment of the present application provides an interaction method, as shown in FIG. 1, which includes steps S110-S140:

S110: acquiring a trajectory point set input by a user, wherein the trajectory point set at least includes one trajectory point;

S120: determining a candidate object according to the trajectory point set, wherein the candidate object includes a first candidate object and a second candidate object;

S130: displaying a first selection icon for representing the first candidate object and a second selection icon for representing the second candidate object; and

S140: displaying the first candidate object or executing an operation corresponding to the first candidate object in response to the user's selection operation on the first selection icon, and displaying the second candidate object or executing an operation corresponding to the second candidate object in response to the user's selection operation on the second selection icon.

The interaction method of the embodiment of the present disclosure may automatically, efficiently and quickly provide various candidate objects related to the trajectory for the user to choose according to a trajectory formed by the user's input, and may display corresponding patterns or perform corresponding operations according to the user's choice, thus greatly improving the user's experience.

In an exemplary embodiment, the above interaction method may be applied to an electronic device including a touch screen such as an electronic whiteboard, a tablet computer and a smart phone. The touch screen may include a touch pad, a sampling unit, a display panel and a display driving unit, wherein the touch pad is a transparent pad provided on an upper surface of the display panel. A user uses a finger or a stylus to perform an input operation, and the sampling unit samples the user's touch so as to obtain real-time coordinates of a trajectory point formed by the contact position of the finger or the stylus with the touch pad. The real-time coordinates are sent to the display driving unit, so that the trajectory point may be displayed at a position on the display panel corresponding to the real-time coordinates. The user uses the finger or stylus to continuously slide on the touch pad to write or draw. Through continuous sampling and sending by the sampling unit, the display panel may display a trajectory formed by the trajectory point set corresponding to multiple real-time coordinates, which is consistent with the trajectory of the user's writing or drawing on the touch pad.

In an exemplary embodiment, the above interaction method may be applied to a system of a tablet plus a computer or a computer equipped with a touch pad, the user's input operation is received through the tablet or touch pad, and the trajectory point formed by the input operation may be displayed on the screen of the computer. In other exemplary embodiments, the user may use a mouse or a keyboard, instead of the touch pad, to manipulate movement of a cursor to input the trajectory point.

In an exemplary embodiment, in step S110, a trajectory point set input by a user in a preset input area (such as an input area corresponding to a dialog box, an editing interface or an interface of a predetermined APP, etc.) may be acquired, or a trajectory point set input by the user in a certain period of time (such as a pause between two operations by the user) may be acquired.

In an exemplary embodiment, in step S120, one or more first candidate objects and one or more second candidate objects may be determined.

In an exemplary embodiment, in step S120, the determined candidate objects may further include a third candidate or more candidate objects.

In an exemplary embodiment, there are multiple first candidate objects and multiple second candidate objects respectively, and correspondingly, there are multiple first selection icons and multiple second selection icons respectively, which respectively correspond to the first candidate objects and the second candidate objects one by one.

In an exemplary embodiment, a category of the candidate object determined in step S120 is an instruction corresponding to a pattern or an operation. The categories of the first candidate object and the second candidate object may both be patterns, or both be instructions, or one of them is a pattern and the other one is an instruction. Accordingly, in step S140, if the category of the candidate object is a pattern and the corresponding first or second selection icon is clicked, a corresponding pattern may be displayed; and if the category of the candidate object is an instruction and the corresponding first or second selection icon is clicked, an operation corresponding to the instruction may be executed.

In an exemplary embodiment, the first selection icon and the second selection icon displayed in step S130 are for the user to click to select the corresponding first and second candidate objects. The states adopted by the first selection icon and the second selection icon may be determined according to the categories of the first and second candidate objects respectively. For example, the first selection icon and the second selection icon may be controls that display content with a thumbnail of a pattern as the icon, or may be controls that display content with description information of an instruction as the icon. The description information may be in form of patterns or characters. For example, if the first candidate object is a “undo” instruction, the first selection icon may be displayed as a counterclockwise arrow. For another example, if the first candidate is a “delete” instruction, the first selection icon may be displayed as “del”.

In an exemplary embodiment, in step S130, the first selection icon and the second selection icon may be displayed at the same time, or the first selection icon and the second selection icon may be displayed in turn. The first selection icon and the second selection icon may be displayed in different areas. The order and area of displaying may be provided according to a default mode, or may be set by the user.

In an exemplary embodiment, in step S140, the user is only allowed to select one selection icon. In response to the user's selection operation (such as but not limited to an operation of clicking or long pressing) on one selection icon (the first selection icon or the second selection icon), the displaying of the first selection icon and the second selection icon may be stopped, and a candidate object corresponding to the selection icon selected by the user is displayed or a corresponding operation is executed according to the corresponding candidate object. That is, the user may select one first candidate or second candidate by selecting the selection icon. According to the category of the candidate object selected by the user, the candidate object is displayed correspondingly, or the operation corresponding to the candidate object is executed.

In an exemplary embodiment, in step S140, the user may be allowed to select two or more selection icons, which may be both the first/second selection icons, or partially be first selection icons and the rest are second selection icons. For example, the user holds down the “ctrl” key and selects a first selection icon and a second selection icon. In response to the user's selection operation, the first candidate object and the second candidate object may be displayed at the same time, or the operations corresponding to the first candidate object and the second candidate object may be executed in turn, or one candidate object is displayed and an operation corresponding to the other candidate object is executed.

In an exemplary embodiment, in step S140, when displaying the candidate object, it may be displayed at a current position of the cursor, or may be displayed by replacing the trajectory formed by the trajectory point set with the candidate object.

In an exemplary embodiment, the first candidate object includes a first candidate pattern, and the second candidate object includes a second candidate pattern.

The step of displaying the first candidate object in response to the user's selection operation on the first selection icon, and displaying the second candidate object in response to the user's selection operation on the second selection icon includes:

displaying the first candidate pattern in response to the user's selection operation on the first selection icon, and displaying the second candidate pattern in response to the user's selection operation on the second selection icon.

The step of determining the candidate object according to the trajectory point set includes:

acquiring first feature information according to a trajectory formed by the trajectory point set, and acquiring a first candidate pattern successfully matched with the first feature information; and

acquiring second feature information according to a trajectory formed by the trajectory point set, and acquiring a second candidate pattern successfully matched with the second feature information;

wherein the first feature information is different from the second feature information.

The first candidate pattern and the second candidate pattern may be but not limited to patterns in a preset pattern database. There may be one or more pattern databases, which may be provided locally, on a server, on cloud, etc.

In an exemplary embodiment, the first feature information and the second feature information respectively include one or more of the following:

one or more character features corresponding to the trajectory;

an original line feature of a pattern formed by the trajectory; and

a contour line feature of the pattern formed by the trajectory.

In addition to the types listed above, other types of feature information may be selected for matching, which is not limited in the present application.

The original line feature refers to the line itself, which is composed of the trajectory points in the trajectory point set and used for forming the pattern.

In an exemplary embodiment, the first candidate object and the second candidate object may be candidate patterns successfully matched with different types of feature information, respectively. For example, the first candidate object is a second candidate pattern successfully matched with a character feature, and the second candidate object is a second candidate pattern successfully matched with the original line feature.

In an exemplary embodiment, the first feature information or the second feature information includes one or more character features corresponding to the trajectory.

The step of acquiring the first/second feature information according to the trajectory formed by the trajectory point set includes:

acquiring one or more character features corresponding to the trajectory formed by the trajectory point set.

The step of acquiring the first/second candidate pattern successfully matched with the first/second feature information includes:

selecting a candidate pattern with a carried label which is at least partially the same as the character feature in the first/second feature information as the first/second candidate pattern, wherein the label carried by the candidate pattern is used to represent contents of the candidate pattern.

In one implementation of this embodiment, one or more character features corresponding to the trajectory may be extracted by (but not limited to) OCR (Optical Character Recognition). Or, other ways may be used for acquiring the character feature(s) corresponding to the trajectory, such as extracting stroke features and stroke order features from the trajectory, and comparing them with corresponding features of different characters in the font to determine the character feature(s) corresponding to the trajectory.

In one implementation of this embodiment, a candidate pattern may have one or more labels, and each label may include one or more characters. In one example, the pattern database is searched for labels with the same contents according to the identified character feature. If any label of one candidate pattern is the same as at least one character feature identified, it may be considered that the candidate pattern is successfully matched.

In one implementation of this embodiment, criteria for successful matching may be voluntarily disposed. It may be set that the label must be the same as all the character features to be successful in matching, for example, if both the acquired character feature and the label are “ [symbol] ” (“umbrella for rain” in Chinese), the matching will succeed. Or, it may be set that a matching is successfully if the label is partially the same as the character feature, for example, if the acquired character feature is “ [symbol] ” (“umbrella” in Chinese) and the label is “ [symbol] ” (“umbrella for rain” in Chinese), it may be determined that the matching is successful. For another example, if the acquired character feature is “ [symbol] ” (“kitty” in Chinese) and the label is “ [symbol] ” (“cat” in Chinese), it may be determined that the matching is successful.

In one implementation of this embodiment, if there are many candidate patterns that have been successfully matched, candidate patterns whose labels are completely the same as the acquired character feature may be preferentially selected. Or, a relevance value or a priority may be added into the label in advance, and candidate patterns corresponding to labels with high relevance values or priorities may be preferentially selected. The relevance value may be used for indicating a degree of correlation between the candidate pattern and the label. In one example, the relevance value between a pattern of umbrella and the label “ [symbol] ” (“umbrella” in Chinese) is 100%, and the relevance value between a pattern of a mushroom and the label “ [symbol] ” is 20%. If multiple candidate patterns are successfully matched according to the character feature “ [symbol] ”, the pattern of umbrella may be preferentially selected.

In an exemplary embodiment, the first feature information or the second feature information includes an original line feature of the pattern formed by the trajectory.

The step of acquiring the first/second candidate pattern successfully matched with the first/second feature information includes:

respectively calculating a first similarity between each candidate pattern and the original line feature in the first/second feature information; and

selecting a candidate pattern whose first similarity meets a first preset condition as the first/second candidate pattern.

In one implementation of this embodiment, the first preset condition may be that the first similarity of the candidate pattern is one of the N highest first similarities. The step of selecting the candidate pattern whose first similarity meets the first preset condition includes: selecting N candidate patterns with the highest first similarities. N is a preset positive integer, which may be the number of the candidate patterns to be displayed for the user to choose.

In another implementation of this embodiment, the first preset condition may be that the first similarity exceeds or reaches a preset first similarity threshold.

In one implementation of this embodiment, the first similarity between a candidate pattern and the original line feature may be calculated as follows:

sampling the original line feature according to a first spacing to obtain a first sampling point set, and sampling the candidate pattern according to the first spacing to obtain a second sampling point set;

pairing the sampling points in the first sampling point set and the second sampling point set with Hungarian pairing algorithm, wherein if the number of sampling points in one sampling point set for pairing is less than that of the other sampling point set, the number of sampling point pairs obtained is equal to the number of sampling points in the sampling point set with fewer sampling points; and

calculating a distance of each sampling point pair respectively, and determining the first similarity between the candidate pattern and the original line feature according to a sum of the distances of all sampling point pairs.

The first spacing may be voluntarily set. For example, if more intensive sampling is required, the first spacing may be set to be smaller.

The distance of a sampling point pair calculated may be, but is not limit to, Euclidean distance, and the smaller the distance, the greater the similarity.

In this embodiment, the calculation of the first similarity is not limited to the above-mentioned method, and other methods may also be used for determining the first similarity between the original line feature and the candidate pattern, such as by calculating cosine similarity, or by calculating similarity through fingerprint information.

In an exemplary embodiment, the first feature information or the second feature information includes an original line feature of the pattern formed by the trajectory.

The step of acquiring the first/second candidate pattern successfully matched with the first/second feature information includes:

performing following operations respectively on each candidate pattern:

calculating a similarity between the original line feature in the first/second feature information and the candidate pattern, and a similarity between the original line feature and a sub-pattern included in the candidate pattern, so as to determine a second similarity between the candidate pattern and the original line feature; and

selecting a candidate pattern whose second similarity meets a second preset condition as the first/second candidate pattern;

wherein the sub-pattern included in the candidate pattern is stored corresponding to the candidate pattern.

In this embodiment, a maximum similarity in the calculated similarity between the original line feature and the candidate pattern and the calculated similarity between the original line feature and the sub-pattern of the candidate pattern may be selected as the similarity with the candidate pattern.

In one implementation of this embodiment, the second preset condition may be that the second similarity of the candidate pattern is one of the N highest second similarities. The step of selecting the candidate pattern whose second similarity meets the second preset condition includes selecting N candidate patterns with the highest second similarities, wherein N is a preset positive integer, which may be the number of the candidate patterns to be displayed for the user to choose.

In another implementation of this embodiment, the second preset condition may be that the second similarity exceeds or reaches a preset second similarity threshold.

In this embodiment, the implementation details for calculating the similarity between the original line feature and the candidate pattern or sub-pattern may refer to the practice of calculating the first similarity.

In this embodiment, a candidate pattern that is partially similar to the pattern formed by the trajectory may be selected, that is, a candidate pattern whose “component” is similar to the pattern formed by the trajectory may be selected.

In this embodiment, in a process of storing the candidate pattern, sub-patterns and the candidate pattern composed of sub-patterns may be stored together, or the sub-patterns may be split from the candidate pattern and stored together with the candidate pattern.

In this embodiment, not every candidate pattern has a sub-pattern, and it is possible that only some of the candidate patterns have sub-patterns. The sum of sub-patterns included in a candidate pattern may be less than that of the candidate pattern. The same portion of the candidate pattern may be used as the same sub-pattern. For example, if the candidate pattern is a house with multiple identical windows, each window may use the same “sub-pattern of window”, while the rest of the “house pattern” is not used as a sub-pattern.

In an exemplary embodiment, the first feature information or the second feature information includes a contour line feature of the pattern formed by the trajectory.

The step of acquiring the first/second candidate pattern successfully matched with the first/second feature information includes:

respectively calculating a third similarity between a contour line of each candidate pattern and the contour line feature in the first/second feature information; and

selecting a candidate pattern whose third similarity meets a third preset condition as the first/second candidate pattern.

In one implementation of this embodiment, the third preset condition may be that the third similarity of the candidate pattern is one of the N highest third similarities. The step of selecting the candidate pattern whose third similarity meets the third preset condition includes selecting N candidate patterns with the highest third similarities, wherein N is a preset positive integer, which may be the number of the candidate patterns to be displayed for the user to choose.

In another implementation of this embodiment, the third preset condition may be that the third similarity exceeds or reaches a preset third similarity threshold.

In this embodiment, a process of calculating the third similarity between a candidate pattern and the contour line feature may include:

extracting a contour line feature from the pattern formed by the trajectory, normalizing the contour line feature, and sampling according to a second spacing to obtain a third sampling point set;

sampling a contour line of the candidate pattern according to the second spacing to obtain a fourth sampling point set;

pairing sampling points in the third sampling point set and the fourth sampling point set with Hungarian pairing algorithm, wherein if the number of sampling points in one sampling point set for pairing is less than that of the other sampling point set, the number of sampling point pairs obtained is equal to the number of sampling points in the sampling point set with fewer sampling points; and

calculating a distance of each sampling point pair respectively, and determining the third similarity between the contour line feature and the contour line of the candidate pattern according to a sum of distances of all sampling point pairs.

The second spacing may be voluntarily set. For example, if more intensive sampling is required, the second spacing may be set to be smaller.

The distance of a sampling point pair calculated may be, but is not limited to, a Euclidean distance.

In this embodiment, the calculation of the third similarity is not limited to the above-mentioned method, and the third similarity may be determined using any method of determining a similarity between curves, such as discrete Frechet distance, Hausdorff distance, pearson correlation coefficient, etc.

In some exemplary embodiments, the first feature information or the second feature information includes a pattern formed by the trajectory or a contour line of the pattern. The step of acquiring the first/second feature information may include:

scaling the pattern formed by the trajectory according to multiple different preset scales.

Correspondingly, a similarity between the original line feature in the first/second feature information and the candidate pattern (or sub-pattern thereof), or a similarity between the contour line feature in the first/second feature information and the contour line of the candidate pattern is calculated according to the pattern scaled in different scales respectively. Different similarities may be calculated according to different scales, and the maximum value among these similarities is taken as the final similarity.

For example, to calculate the first similarity between the original line feature IMG₁ and the candidate pattern IMG₂, first IMG₁ is scaled according to the preset scaling ratio of 0.5, 1 and 2 to obtain IMG₁₋₁, IMG₁₋₂, and IMG₁₋₃ respectively. IMG₁₋₁ and IMG₂ are intensively sampled at equal interval, then the two sampling point sets obtained are subjected to Hungarian pairing, and then the distance of each sampling point pair is calculated to obtain a total distance L₁₋₁. Similarly, for IMG₁₋₂ and IMG₁₋₃, distance sums L₁₋₂ and L₁₋₃ are obtained respectively. The final first similarity between IMG₁ and IMG₂ is determined according to a minimum value (corresponding to the greatest similarity) among the three distance sums as the final distance.

This embodiment may reduce the influence of pattern size on distance (or similarity) calculation.

In this embodiment, the preset scale may be set to 0.1, 0.2, . . . , 9, 10.

In an exemplary embodiment, the first candidate includes a first candidate instruction, and the second candidate includes a second candidate instruction.

The step of executing the operation corresponding to the first candidate object in response to the user's selection operation on first selection icon, and executing the operation corresponding to the second candidate object in response to the user's selection operation on the second selection icon includes:

executing an operation corresponding to the first candidate instruction in response to the user's selection operation on the first selection icon, and executing an operation corresponding to the second candidate instruction in response to the user's selection operation on the second selection icon.

The step of determining the candidate object according to the trajectory point set includes:

identifying a trajectory formed by the trajectory point set as a standard trajectory, and acquiring different candidate instructions according to the standard trajectory as the first candidate instruction and the second candidate instruction respectively.

In one implementation of this embodiment, the trajectory may be identified as different first and second standard trajectories, a candidate instruction corresponding to the first standard trajectory may be acquired as the first candidate instruction, and a candidate instruction corresponding to the second standard trajectory may be acquired as the second standard instruction.

In another implementation of this embodiment, the trajectory may be identified as a standard trajectory, and multiple candidate instructions corresponding to the standard trajectory may be acquired as the first candidate instruction and the second candidate instruction respectively.

In this embodiment, if multiple standard trajectories are identified, they may be sorted according to the similarity between the multiple standard trajectories and the trajectory formed by the trajectory point set, and the standard trajectories with the highest ranking may be selected to acquire the first candidate instruction and the second candidate instruction.

In this embodiment, the standard trajectory is a trajectory with a standardized shape. Due to very high personalized degree of the trajectory input by the user, even if users intend to input the same trajectory (for example, all of the users intend to input the trajectory “Z”), the trajectories actually input by different users will be different in shape, and even the trajectories input by the same user twice in succession will be different. In order to adapt to this differentiated input, it is necessary to identify a trajectory input by the user as the standard trajectory and then acquire the candidate instructions accordingly, that is, to carry out a “standardization” process first. The process of identifying the trajectory as a standard trajectory may adopt a method similar to that of identifying the characters input by the user in handwriting input: extracting a feature of the trajectory and comparing the feature with a feature of the standard trajectory to identify the trajectory as one of preset standard trajectories. If the feature of the trajectory input by the user cannot be identified as any standard trajectory, it means that the trajectory input by the user has no corresponding candidate instruction, and the candidate object whose category is the candidate instruction cannot be acquired according to the trajectory input by the user.

In this embodiment, multiple standard trajectories may be preset, and one or more candidate instructions corresponding to each standard trajectory may be set. The style of the standard trajectory may be any one or more of the following: pattern, symbol and character.

In this embodiment, the trajectory input by the user may be identified as more than one standard trajectory. For example, if the user inputs an oblique “Z”, it may be identified as a standard trajectory “Z” or a standard trajectory “N”, candidate instructions corresponding to “Z” and “N” may be acquired, and the candidate instruction corresponding to “Z” may be taken as the first candidate object and the candidate instruction corresponding to “N” may be taken as the second candidate object.

In another exemplary embodiment, the first candidate object and the second candidate object may be different candidate instructions corresponding to one standard trajectory. For example, the standard trajectory “Z” corresponds to two instructions: delete trajectory and empty dialog box. These two instructions may be regarded as the first candidate object and the second candidate object respectively.

In an exemplary embodiment, the first candidate object is a third candidate pattern, and the second candidate object is a third candidate instruction;

the step of determining the candidate object according to the trajectory point set includes:

The step of displaying the first candidate object in response to the user's selection operation on the first selection icon and executing the operation corresponding to the second candidate object in response to the user's selection operation on the second selection icon includes:

displaying the third candidate pattern in response to the user's selection operation on the first selection icon and executing an operation corresponding to the third candidate instruction in response to the user's selection operation on the second selection icon.

The step of determining the candidate object according to the trajectory point set includes:

acquiring third feature information according to a trajectory formed by the trajectory point set, and acquiring a third candidate pattern successfully matched with the third feature information; and

identifying the trajectory formed by the trajectory point set as a standard trajectory, and acquiring the third candidate instruction according to the standard trajectory.

In one implementation of this embodiment, the step of determining the candidate object according to the trajectory point set may further includes:

acquiring a fourth feature information according to a trajectory formed by the trajectory point set in response to the failure of identifying the trajectory formed by the trajectory point set as a standard trajectory, and acquiring a fourth candidate pattern successfully matched with the fourth feature information as the second candidate object, wherein the fourth feature information is different from the third feature information.

In this embodiment, by default, one of the first candidate object and the second candidate object is a candidate pattern and the other one is a candidate instruction. However, if the trajectory input by the user cannot be identified as the standard trajectory, that is, the candidate instruction cannot be obtained, then the second candidate object may be adaptively changed to a candidate pattern which is successfully matched according to the fourth feature information different from the third feature information.

In an exemplary embodiment, the above interaction method may be applied to writing software, and the step of acquiring the trajectory point set input by the user includes:

acquiring a trajectory point set input by the user in an input interface in response to the user's input operation in the input interface of the writing software;

the step of displaying the first selection icon for representing the first candidate object and the second selection icon for representing the second candidate object includes:

displaying a first selection icon for representing the first candidate object and a second selection icon for representing the second candidate object in the input interface of the writing software.

The step of displaying the first candidate object or executing an operation corresponding to the first candidate object in response to the user's selection operation on the first selection icon, and displaying the second candidate object or executing an operation corresponding to the second candidate object in response to the user's selection operation on the second selection icon includes:

displaying the first candidate object in the input interface or executing the operation corresponding to the first candidate object in the writing software in response to the user's selection operation on the first selection icon in the input interface of the writing software; and

displaying the second candidate object in the input interface or executing the operation corresponding to the second candidate object in the writing software in response to the user's selection operation on the second selection icon in the input interface.

In an exemplary embodiment, the step of displaying the first selection icon for representing the first candidate object and the second selection icon for representing the second candidate object includes:

displaying a thumbnail of the first candidate object as the first selection icon if the first candidate object is a candidate pattern; or displaying description information corresponding to the first candidate object as the first selection icon if the first candidate object is a candidate instruction; and

displaying a thumbnail of the second candidate object as the first selection icon if the second candidate object is a candidate pattern; or displaying description information corresponding to the second candidate object as the second selection icon if the second candidate object is a candidate instruction.

In an exemplary embodiment, the step of displaying the first selection icon for representing the first candidate object and the second selection icon for representing the second candidate object further includes:

updating the determined first candidate object and/or the second candidate object in response to a predetermined operation by the user; and

updating the displayed first selection icon correspondingly in response to update of the first candidate object, and updating the displayed second selection icon correspondingly in response to update of the second candidate.

In this embodiment, for example, after the user clicks a control indicating “More” or an icon indicating “Refresh”, another batch of candidate objects may be acquired (such as candidate patterns that have been successfully matched but not displayed, candidate patterns that have been re-selected according to other feature information, and candidate instructions re-acquired by identifying the trajectory as other standard trajectory, etc.), and the displayed selection icons may be updated accordingly.

In an exemplary embodiment, the step of acquiring the trajectory point set input by the user includes:

displaying a preset control in response to a pause of the user's input operation, wherein detecting the pause of the user's input operation means that time length from the last receiving of the sampling result of the input operation reaches or exceeds a preset time threshold; and

acquiring trajectory points corresponding to the user's input operation between a current detection of the user's input operation pause and a previous detection of the user's input operation pause in response to the user's operation on the preset control, and saving the trajectory points as a trajectory point set.

In this embodiment, the trajectory point set input in a specific time period (between two operation pauses) is acquired, while in other embodiments, the trajectory point set input in a predetermined input area may be acquired.

An embodiment of the present application further provides an electronic device including a memory 21 and a processor 22 as shown in FIG. 2;

the memory 21 is configured to store a program for interaction; and

the processor 22 is configured to read and execute the program for interaction and perform the interaction method in any one of the above embodiments.

In an exemplary embodiment, the electronic device may further include:

a touch pad configured to receive an input operation by a user;

a sampling unit, a display panel and a display driving unit. Real-time coordinates of a touch position are sampled by the sampling unit and sent to the display driving unit, which may be displayed correspondingly on the display panel according to the user's input operation on the touch panel. The display driving unit may also display all or part of successfully matched candidate patterns on the display panel according to control of the processor.

An embodiment of the present application further provides a computer storage medium configured to store a program for interaction, wherein the interaction method of any one of the above embodiments is carried out when the program for interaction is executed.

The embodiments of the present application will be explained with two examples below.

### EXAMPLE 1

This example is applied to an electronic whiteboard, which includes a touch screen, a memory and a processor. The candidate objects include first, second and third candidate objects, all of which are candidate patterns.

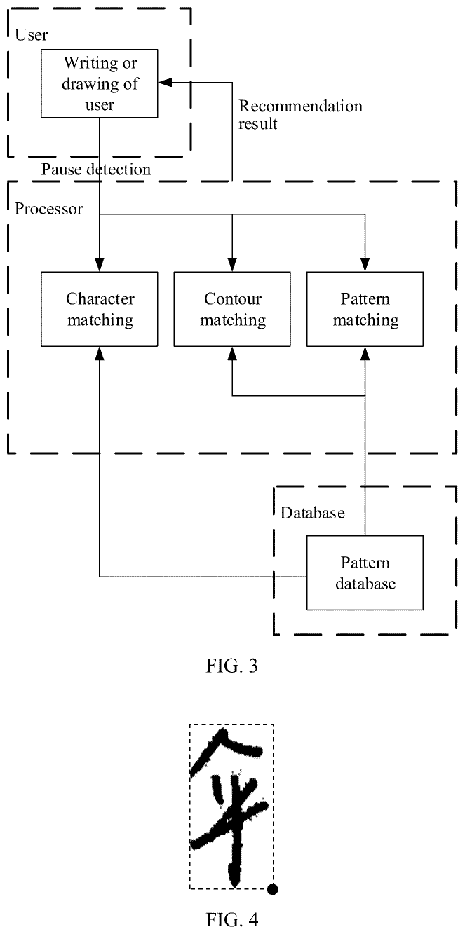

The overall implementation flow of this example is shown in FIG. 3:

When the user writes or draws on the electronic whiteboard, the processor detects a pause of the user, identifies a trajectory point set formed by the user's writing or drawing to acquire candidate patterns, which are returned to the front end as recommendation results and displayed in the form of a selection icon for the user to choose.

In this example, the way of acquiring a candidate pattern includes: acquiring three types of feature information from the trajectory formed by the trajectory point set, and matching the three types of feature information with candidate patterns in the pattern database. According to different types of acquired feature information, matching methods are as follows:

character matching (matching is performed according to a character feature corresponding to the trajectory in this method), contour line matching (matching is performed according to a contour line feature of the pattern formed by the trajectory in this method) and pattern matching (matching is performed according to an original line feature of the pattern formed by the trajectory in this method).

In this example, the sampling unit may send the sampled real-time coordinates of the user's touch on the whiteboard to the processor. When the processor detects a pause of the user' operation, it will trigger a start of an interactive operation. Detecting the pause of the user' operation may mean that a time length from the last time the real-time coordinates are received from the sampling unit exceeds a preset time threshold.

In this example, after the interactive operation starts, the processor displays a dashed box with interactive trigger points on the display panel by controlling the display driving unit to send an interactive request to the user. The dashed box frames the trajectory from the last detection of the pause to the current detection of the pause, as shown in FIG. 4. That is, the trajectory in the dashed box is the trajectory formed by the acquired trajectory point set, including multiple trajectory points from the first trajectory point received after the last detection of the pause to the last trajectory point received before the current detection of the pause.

In addition to the dashed box used in this example, other forms may be used to identify the acquired trajectory point set, such as changing a color of the corresponding trajectory or changing the background color of an area including the corresponding trajectory to highlight.

In this example, the interactive trigger point is set as a dot with a certain area in the lower right corner of the dashed box, and the trigger mode is to click on the dot. During implementation, the interactive trigger point may be displayed in other forms and located in other positions, and the trigger mode may be varied. For example, the interactive trigger point may be set as an icon in a menu bar, or may be set on a border of the dashed box or in an area within the dashed box. For another example, interaction may be triggered directly by double-clicking or long-pressing without providing an interactive point.

In this example, after displaying the dashed box, the processor determines the user's operation according to one or more actual coordinates subsequently sampled by the sampling unit, and carries out corresponding processing, including the following five cases:
(1) The user continues to write or draw in the dashed box:

without processing, the processor records a time moment of this pause and continues to monitor until a next pause.
(2) The user continues to write or draw outside the dashed box:

without processing, the processor records a time moment of this pause and continues to monitor until a next pause.
(3) The user long-presses or holds down any position in the dashed box and drags it:

according to the user's drag, the processor correspondingly changes the coordinates of the trajectory in the dashed box, and sends the changed coordinates to the display driving unit, so that an effect displayed on the display panel is that the trajectory in the dashed box moves correspondingly with the user's drag.
(4) The user long-presses or holds down the interactive trigger point at the lower right corner of the dashed box and drags:

according to the user's drag, the processor correspondingly changes a distance between adjacent trajectory points in the trajectory, keeps coordinates of one trajectory point unchanged, while changes coordinates of other trajectory points with the change of the distance; the processor sends the changed coordinates to the display driving unit, so that an effect displayed on the display panel is that the trajectory in the dashed box scales with the user's drag.
(5) The user clicks on the interaction trigger point at the lower right corner of the dashed box:

the processor acquires three types of feature information of the trajectory in the dashed box: character feature, original line feature and contour line feature of the formed pattern, connects with a local or remote pattern database, and respectively matches with candidate patterns included in the pattern database according to each type of the acquired feature information to obtain a candidate object corresponding to each type of feature information, that is, a candidate pattern that is successfully matched according to this type of feature information. The processor returns all or part of the successfully matched candidate patterns to the front end as candidate objects for display. In this example, the first candidate object is a candidate pattern that is successfully matched according to the character feature corresponding to the trajectory, the second candidate is a candidate pattern that is successfully matched according to the contour line feature of the pattern formed by the trajectory, and the third candidate is a candidate pattern that is successfully matched according to the original line feature of the pattern formed by the trajectory.

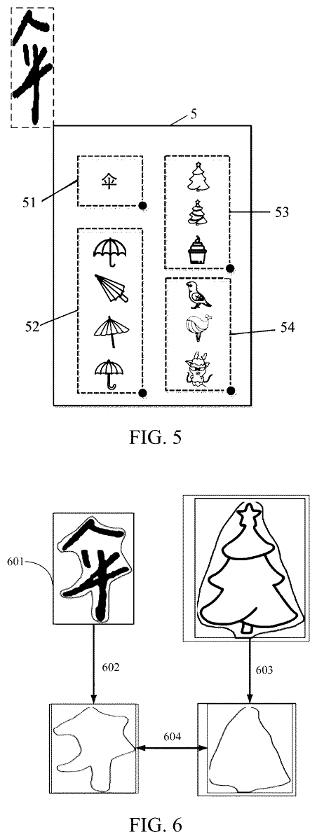

As shown in FIG. 5, four first selection icons, three second selection icons and three third selection icons are displayed to the user, which are thumbnails corresponding to the first, second and third candidate objects respectively. In this example, characters corresponding to the trajectory are also displayed.

In this example, the processor displays the corresponding candidate objects in response to the user's click on any of the selection icons. One way is to display a candidate object selected by the user in the dashed box instead of the original trajectory in the dashed box. In this implementation, the candidate object may be scaled according to the size of the dashed box. Another way is to display the candidate object selected by the user at a predetermined position or any position according to the original size, so that the user may drag and scale by himself as needed.

In addition to the mode of selecting by clicking, the corresponding candidate object may be displayed in response to the user's long pressing on any selection icon.

In FIG. 5, a pattern recommendation area 5 may include four sub-areas, which respectively display different contents.

Displayed in the OCR result sub-area 51 is the best recognition result obtained by OCR on the trajectory, which is taken as the character corresponding to the trajectory, and a Chinese character “ [symbol] ” is taken as an example in FIG. 5.

Displayed in a character pattern recommendation sub-area 52 is the first selection icon of the first candidate object obtained by matching the OCR result as feature information, that is, finding a corresponding candidate pattern for recommendation according to the acquired character feature.

Displayed in a similar pattern recommendation sub-area 53 is the second selection icon of the second candidate obtained by matching according to the contour line feature of the pattern formed by the trajectory.

Displayed in an inclusion pattern recommendation sub-area 54 is the third selection icon of the third candidate obtained by matching according to the original line feature of the pattern formed by the trajectory.

In this example, boundaries of the four sub-regions may each be marked with a dashed box. An interactive trigger point may be set for each of the sub-areas, which in this example is set at the lower right corner of the dashed box of the sub-area. When the user clicks on the interactive trigger point for displaying the OCR result sub-area 51, other alternative OCR results will be displayed in this sub-area or a new area, such as displaying sub-optimal recognition results, which may solve the problem that the user needs to choose the recognition results independently if he/she is not satisfied with the OCR results. If the user selects other OCR results, the first candidate object is re-acquired according to the results, and the first selection icon is refreshed. When the user clicks on the interactive trigger point of any of the other three sub-areas, the selection icons of more candidate objects may be displayed in the corresponding sub-areas.

In this example, details of acquiring candidate patterns according to different types of feature information are as follows:

(1) Character Pattern Recommendation

In this example, when performing pattern recommendation according to the character feature corresponding to the trajectory, the character corresponding to the trajectory is first identified by OCR, and a recognition result is taken as the acquired character feature. The recognition result may be one character or multiple characters, for example, the recognition result is a word. The characters in this example include Chinese characters, letters, etc.

Matching is performed in the pattern database according to the recognition result. The candidate pattern included in the pattern database carries a label, which is used for indicating the contents of the candidate pattern. When the label and the acquired at least one character feature are the same, it is determined that the matching is successful.

In response to the user's clicking on the interactive trigger point of the character pattern recommendation sub-area 52, part or all of the successfully matched candidate patterns that are not displayed may be selected for display.

(2) Similar Pattern Recommendation

Similar patterns in this example mean that patterns have similar contour lines.

Considering that the user's handwriting is not necessarily a character, it is possible to draw a stick figure to search for the pattern. In this case, it is meaningless to make recommendations according to the OCR results, therefore the method of searching for similar patterns may be used for making recommendations.

In this example, the process of recommending similar patterns includes: calculating a similarity between the contour line feature of the pattern formed by the trajectory and a contour line of each candidate pattern in the pattern database, acquiring the candidate patterns whose contour line similarities ranks in the top three as the second candidate objects, and displaying the corresponding second selection icons. For example, in the case of FIG. 5, thumbnails of candidate patterns corresponding to the similarities ranked first to third are displayed after the similarities are ranked from high to low. In response to the user's clicking on the interactive trigger point of the similar pattern recommendation sub-area 53, according to the arrangement order of similarities, the candidate patterns corresponding to the similarities ranked fourth to sixth are re-acquired as the second candidate objects, and the displayed second selection icons are correspondingly updated.

As shown in FIG. 6, calculation of similarity of a contour line includes the following steps 601-604:

601: firstly extracting the contour line feature of the pattern formed by the trajectory in the dashed box;

602: normalizing the extracted contour line feature;

steps 603 and 604 are respectively performed for each candidate pattern in the pattern database:

603: extracting a contour line feature of the candidate pattern; and

604: calculating a similarity of the contour line feature.

The contour line feature of each candidate pattern in the pattern database may be extracted and saved in advance, that is, step 603 may be completed in advance, so that step 604 may be directly carried out after step 602 during matching so as to save time. The candidate patterns in the database are generally standard patterns, so there is no need to normalize them. If they are not standard patterns, they should also be normalized after extracting the contour line feature.

In this example, in step 604, the similarity between contour lines may be calculated as follows:

The contour line features of the candidate pattern and the pattern formed by the trajectory are intensively sampled at equal intervals respectively. The sampling points in the two sampling point sets obtained by sampling are paired in pairs according to Hungarian matching algorithm, the distance of each sampling point pair is calculated, and the similarity of contour lines is determined according to the sum of the distances of all sampling point pairs.

The calculated distance may be, but is not limited to, a Euclidean distance. When pairing, if the number of sampling points in two sampling point sets is different, for example, one is M, the other is N, and N is greater than M, M sampling point pairs are obtained.

(3) Inclusion Pattern Recommendation

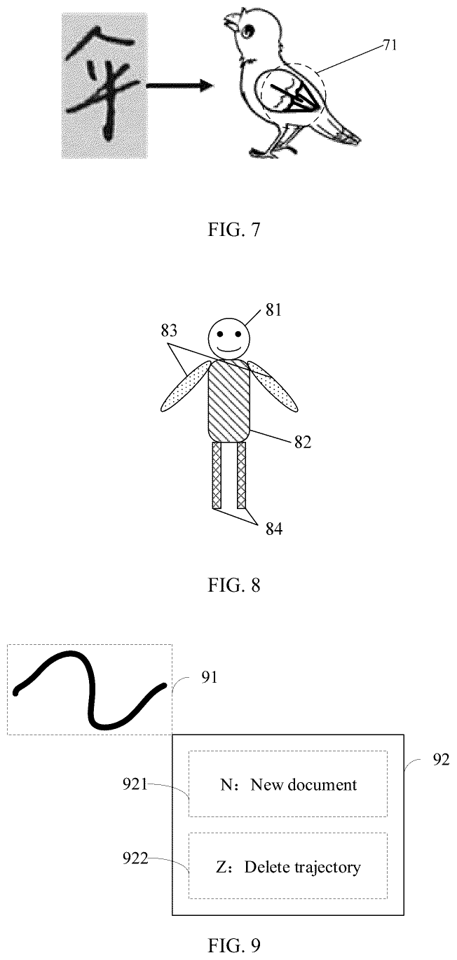

In this example, inclusion pattern means that the original line feature of the pattern formed by the trajectory is similar to the “component” in the candidate pattern, that is, the pattern formed by the trajectory is similar to the shape of a sub-pattern in the candidate pattern. As shown in FIG. 7, the pattern formed by the trajectory is similar to the shape of “Wing” in the sub-pattern 71 of the candidate pattern “Bird”, and the candidate pattern “Bird” is acquired as the third candidate object.

When calculating the similarity, the original line feature of the pattern formed by the trajectory and the line feature in the candidate pattern (or the sub-pattern of the candidate pattern) may be first intensively sampled at equal intervals respectively. The sampling points in the two sampling point sets obtained by sampling are paired in pairs according to Hungarian matching algorithm, the distance of each sampling point pair is calculated, and the similarity of the two patterns is determined according to the sum of the distances of all sampling point pairs. The calculated distance may be, but is not limited to, a Euclidean distance.

In this example, the candidate pattern in the pattern database may have one or more sub-patterns, such as the situation shown in FIG. 8. The candidate pattern “Animated Villain” may have four sub-patterns: head 81, torso 82, arms 83 (the left arm and right arm use the same sub-pattern) and legs 84 (the left leg and right leg use the same sub-pattern). When the pattern formed by the trajectory is similar to the head 81, the candidate pattern of “Animated Villain” may be successfully matched.

For a candidate pattern with sub-patterns, the similarities between the original line feature of the pattern formed by the trajectory and the original line feature of the candidate pattern and sub-patterns may be calculated respectively, and the maximum similarity among the calculated similarities may be taken as the final similarity between the candidate pattern and the pattern formed by the trajectory.

### EXAMPLE 2

In this example, the first and second candidate objects are the first and second candidate instructions by default, respectively. The displayed first selection icon and second selection icon are the description information of the instruction. In this example, the trajectory input by the user is identified as one or more of the preset standard trajectories, corresponding candidate instructions are acquired as the first and second candidate objects according to the identified standard trajectories, corresponding selection icons are displayed, and corresponding operations are executed in response to the user clicking on the selection icons.

In this example, the selection icon displayed to the user is shown in FIG. 9, and the trajectory formed by the trajectory point set input by the user is shown in area 91. Two standard trajectories, “Z” and “N”, may be identified for this trajectory point set. The candidate instruction corresponding to the standard trajectory “N” is acquired as the first candidate object, and the description information “N: new document” corresponding to “N” is acquired as the first selection icon 921, which is displayed in the selection icon area 92. The candidate instruction corresponding to the standard trajectory “Z” is acquired as the second candidate object, and the description information “Z: delete trajectory” corresponding to “Z” is acquired as the second selection icon 922, which is displayed in the selection icon area 92. The user clicks the first selection icon 921 to create a new document in the current application, and the user clicks the second selection icon 922 to delete the trajectory in the area 91.

In this example, the description information of the candidate instruction used by the selection icon may be replaced by the icon of the candidate instruction or the content of the candidate instruction.

In this example, a standard trajectory may correspond to multiple candidate instructions. For example, if the standard trajectory “N” corresponds to multiple candidate instructions, these candidate instructions may be acquired as different first candidate objects, and the corresponding first selection icons are displayed respectively.

In a variation of this example, one of the first and second candidate objects may be changed into a candidate pattern. All the identified candidate instructions corresponding to the standard trajectory are taken as another candidate object. The candidate pattern as a candidate object may be selected by one or more types of feature information.

In this example, if the standard trajectory cannot be identified for the trajectory input by the user, the candidate object may be adaptively changed to the candidate pattern. For example, if the trajectory input by the user may only be identified as a standard trajectory, the candidate instruction corresponding to the standard trajectory is acquired as the first candidate object, and the feature information of the preset type is extracted from the trajectory to select the candidate pattern and acquire it as the second candidate object. If the trajectory input by the user cannot be identified as any standard trajectory, candidate patterns may be selected as the first and second candidate objects according to different types of feature information.

The drawings of the present disclosure only relate to the implementations involved in the present disclosure, and other implementations may be designed with reference thereto. Without conflict, the embodiments of the present application and the features in the embodiments may be combined with each other to obtain new embodiments.

Those of ordinary skill in the art should know that modifications or equivalent replacements may be made to the technical solutions of the present disclosure without departing from the spirit and scope of the technical solutions of the present disclosure, and the modifications or equivalent replacements shall all fall within the scope of the claims of the present disclosure.

1. An interaction method, comprising:
acquiring a trajectory point set input by a user, wherein the trajectory point set at least comprises one trajectory point;
determining a candidate object according to the trajectory point set, wherein the candidate object comprises a first candidate object and a second candidate object;
displaying a first selection icon for representing the first candidate object and a second selection icon for representing the second candidate object; and
displaying the first candidate object or executing an operation corresponding to the first candidate object in response to the user's selection operation on the first selection icon, and displaying the second candidate object or executing an operation corresponding to the second candidate object in response to the user's selection operation on the second selection icon.

2. The interaction method according to claim 1, wherein the first candidate object comprises a first candidate pattern and the second candidate object comprises a second candidate pattern;
displaying the first candidate object in response to the user's selection operation on the first selection icon, and displaying the second candidate object in response to the user's selection operation on the second selection icon comprises:
displaying the first candidate pattern in response to the user's selection operation on the first selection icon, and displaying the second candidate pattern in response to the user's selection operation on the second selection icon;
determining the candidate object according to the trajectory point set comprises:
acquiring first feature information according to a trajectory formed by the trajectory point set, and acquiring the first candidate pattern successfully matched with the first feature information, and
acquiring second feature information according to the trajectory formed by the trajectory point set, and acquiring the second candidate pattern successfully matched with the second feature information;
wherein the first feature information is different from the second feature information.

3. The interaction method according to claim 2, wherein the first feature information and the second feature information respectively comprise one or more of the following:
one or more character features corresponding to the trajectory;
an original line feature of a pattern formed by the trajectory; and
a contour line feature of the pattern formed by the trajectory.

4. The interaction method according to claim 3, wherein the first feature information or the second feature information comprises one or more character features corresponding to the trajectory; acquiring the first feature information or the second feature information according to the trajectory formed by the trajectory point set comprises:
extracting one or more character features corresponding to the trajectory formed by the trajectory point set;
acquiring the first/second candidate pattern successfully matched with the first/second feature information comprises:
selecting a candidate pattern with a carried label which is at least partially the same as a character feature in the first/second feature information as the first/second candidate pattern;
wherein the label carried by the candidate pattern is used for representing contents of the candidate pattern.

5. The interaction method according to claim 3, wherein the first feature information or the second feature information comprises the original line feature of the pattern formed by the trajectory;
acquiring the first/second candidate pattern successfully matched with the first/second feature information comprises:
respectively calculating a first similarity between each candidate pattern and the original line feature in the first/second feature information; and
selecting a candidate pattern whose first similarity meets a first preset condition as the first/second candidate pattern.

6. The interaction method according to claim 3, wherein the first feature information or the second feature information comprises the original line feature of the pattern formed by the trajectory;
acquiring the first/second candidate pattern successfully matched with the first/second feature information comprises:
performing following operations respectively for each candidate pattern:
calculating a similarity between the original line feature in the first/second candidate pattern and the candidate pattern, and a similarity between the original line feature and a sub-pattern comprised in the candidate pattern, so as to determine a second similarity with the candidate pattern; and
selecting a candidate pattern whose second similarity meets a second preset condition as the first/second candidate pattern;
wherein the sub-pattern comprised in the candidate pattern is stored corresponding to the candidate pattern.

7. The interaction method according to claim 3, wherein the first feature information or the second feature information comprises the contour line feature of the pattern formed by the trajectory;
acquiring the first/second candidate pattern successfully matched with the first/second feature information comprises:
respectively calculating a third similarity between a contour line of each candidate pattern and the contour line feature in the first/second feature information; and
selecting the candidate pattern whose third similarity meets a third preset condition as the first/second candidate pattern.

8. The interaction method according to claim 1, wherein the first candidate object comprises a first candidate instruction and the second candidate object comprises a second candidate instruction;
executing the operation corresponding to the first candidate object in response to the user's selection operation on the first selection icon and executing the operation corresponding to the second candidate object in response to the user's selection operation on the second selection icon comprises:
executing an operation corresponding to the first candidate instruction in response to the user's selection operation on the first selection icon, and executing the operation corresponding to the second candidate instruction in response to the user's selection operation on the second selection icon;
determining the candidate object according to the trajectory point set comprises:
identifying a trajectory formed by the trajectory point set as a standard trajectory, and acquiring different candidate instructions according to the standard trajectory as the first candidate instruction and the second candidate instruction respectively.

9. The interaction method according to claim 1, wherein the first candidate object is a third candidate pattern and the second candidate object is a third candidate instruction;
displaying the first candidate object in response to the user's selection operation on the first selection icon and executing an operation corresponding to the second candidate object in response to the user's selection operation on the second selection icon comprises:
displaying the third candidate pattern in response to the user's selection operation on the first selection icon, and executing an operation corresponding to the third candidate instruction in response to the user's selection operation on the second selection icon;
determining the candidate object according to the trajectory point set comprises:
acquiring third feature information according to a trajectory formed by the trajectory point set, and acquiring a third candidate pattern successfully matched with the third feature information; and
identifying the trajectory formed by the trajectory point set as a standard trajectory, and
acquiring the third candidate instruction according to the standard trajectory.

10. The interaction method according to claim 9, wherein determining the candidate object according to the trajectory point set further comprises:
acquiring a fourth feature information according to the trajectory formed by the trajectory point set in response to a failure of identifying the trajectory formed by the trajectory point set as the standard trajectory, and acquiring a fourth candidate pattern successfully matched with the fourth feature information as the second candidate object, wherein the fourth feature information is different from the third feature information.

11. The interaction method according to claim 1, wherein the interaction method is applied to writing software; acquiring the trajectory point set input by the user comprises:
acquiring the trajectory point set input by the user in an input interface in response to the user's input operation in the input interface of the writing software;
displaying the first selection icon for representing the first candidate object and the second selection icon for representing the second candidate object comprises:
displaying the first selection icon for representing the first candidate object and the second selection icon for representing the second candidate object in the input interface;
displaying the first candidate object or executing the operation corresponding to the first candidate object in response to the user's selection operation on the first selection icon, and displaying the second candidate object or executing the operation corresponding to the second candidate object in response to the user's selection operation on the second selection icon comprises:
displaying the first candidate object in the input interface or executing the operation corresponding to the first candidate object in the writing software in response to the user's selection operation on the first selection icon in the input interface; and
displaying the second candidate object in the input interface or executing the operation corresponding to the second candidate object in the writing software in response to the user's selection operation on the second selection icon in the input interface.

12. The interaction method according to claim 1, wherein displaying the first selection icon for representing the first candidate object and the second selection icon for representing the second candidate object comprises: displaying a thumbnail of the first candidate object as the first selection icon in a case that the first candidate object is a candidate pattern; or displaying description information of the first candidate object as the first selection icon in a case that the first candidate object is a candidate instruction; and
displaying a thumbnail of the second candidate object as the first selection icon in a case that the second candidate object is a candidate pattern; or displaying description information of the second candidate object as the second selection icon in a case that the second candidate object is a candidate instruction;

13. The interaction method according to claim 1, wherein displaying the first selection icon for representing the first candidate object and the second selection icon for representing the second candidate object further comprises:
updating the determined first candidate object and/or second candidate object in response to a predetermined operation by the user; and
updating the displayed first selection icon correspondingly in response to update of the first candidate object; and updating the displayed second selection icon correspondingly in response to the update of the second candidate.

14. The interaction method according to claim 1, wherein acquiring the trajectory point set input by the user comprises:
displaying a preset control in response to a pause of the user's input operation, wherein detecting the pause of the user's input operation means that a time length from the last time a sampling result of the input operation is received reaches or exceeds a preset time threshold; and
acquiring trajectory points corresponding to the user's input operation between a current detection of the user's input operation pause and a previous detection of the user's input operation pause in response to the user's operation on the preset control, and saving the trajectory points as the trajectory point set.

15. An electronic device comprising: a memory and a processor;
wherein the memory is configured to store a program for interaction; and
the processor is configured to read and execute the program for interaction and perform the interaction method according to claim 1.

16. A computer storage medium configured to store a program for interaction, wherein the interaction method according to claim 1 is performed when the program for interaction is executed.
